(19) United States
(12) Patent Application Publication
(10) Pub. No.: US 2011/0038099 A1
(43) Pub. Date: Feb. 17, 2011

(54) ULTRACAPACITOR POWER STORAGE DEVICE

(76) Inventors: Julius Regalado, Gainesville, FL (US); Jon K. West, Gainesville, FL (US); Robert L. Burns, The Villages, FL (US); Mark Kohler, Ocala, FL (US)

Correspondence Address: LAW OFFICE OF DAVID MCEWING, P.O. BOX 70410, HOUSTON, TX, 77270, US

(21) Appl. No.: 11/937,039

(22) Filed: Nov. 8, 2007

Related U.S. Application Data
(60) Provisional application No. 60/893,564, filed on Mar. 7, 2007.

(51) Int. Cl. H01G 9/155; B32B 37/02; B32B 38/00

(52) U.S. Cl. 361/502; 156/60; 156/281; 977/742; 977/948

(57) ABSTRACT

The specification discloses a method of making an ultracapacitor including the steps of forming a first electrode by adhering CNT on a porous first substrate; placing a non conductive separator over the first electrode, forming a second electrode by adhering a second layer of CNT to a second substrate and placing over the first substrate, attaching a conductive tab to each electrode, rolling the combined electrodes, inserting the rolled electrodes into a metal can, attaching one conductive tab to the bottom of the can, adding an electrolyte to the can, attaching the second conductive tab to a lid of the can, and placing an insulator between the lid and the can.

### RELATED APPLICATION

This application claims priority to and benefit of provisional application No. 60893564 entitled “Multifunctional Power Storage Device” filed Mar. 7, 2007 and which is incorporated herein by reference. This application also incorporates by reference the contents of the non provisional application entitled “Multifunctional Power Storage Device” filed the same date as this application.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of contract No. HQ0006-05-C-7220.

### BACKGROUND OF INVENTION

1. Field of Use

The invention pertains to the method of manufacture and application of wound ultracapacitors, particularly ultracapacitors utilizing carbon nanotubes (“CNT”)

2. Prior Art

Methods of manufacturing some ultracapacitors are known in the prior art. For example reference is made to U.S. Pat. No. 7,095,603.

### SUMMARY OF INVENTION

Ultracapacitors are electrochemical capacitors with unusually high energy density when compared to common capacitors. One area of interest is use of the ultracapacitors for the storage of electrical power. They can be replacements or supplements to batteries.

### SUMMARY OF DRAWINGS

FIGS. 1A and 1B illustrate the forming of two electrodes as taught by the invention.

FIG. 2 illustrates a side view of the completed electrode.

FIG. 3 illustrates the configuration of the rolled electrode and the can with the lid and seal/insulator.

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

### DETAILED DESCRIPTION OF INVENTION

The above general description and the following detailed description are merely illustrative of the subject apparatus and method and additional modes, advantages and particulars of this invention will be readily suggested to those skilled in the art without departing from the spirit and scope of the invention.

The specification discloses a novel method of manufacturing multi-walled Carbon Nanotubes (CNT). The specification also discloses a novel electrolyte that achieves unprecedented power when used in combination with the ultracapacitor electrode of at least one embodiment. The specification discloses placing the CNT and electrolyte into a metal can be dimensioned to the size of a D-cell battery and used as a power source.

The device and method subject of this disclosure pertains in one embodiment to an ultracapacitor comprising carbon nanotubes manufactured from Nickel sintered on a metal substrate at 900° C. in argon (or Nitrogen) atmosphere and, after sintering is completed, growth of CNT by introducing hydrocarbon methane or ethylene. The substrate may comprise stainless steel or Nickel.

In one embodiment, the process begins with a metal foil electrode of nickel or stainless steel. The electrode is coated with nickel chrome powder, stainless steel powder and a catalyst solution. In one embodiment, the Nickel substrate is coated with Nickel-Chrome powder. In another embodiment, a stainless steel substrate is coated with stainless steel powder. The next step is chemical vapor deposition (CVD) processing at 900° C. sintering for 30 minutes. Included is CNT growth processing within a temperature range of 600° C. to 1,200° C. with hydrogen and hydrocarbon precursors. This process achieves a CNT enhanced electrode.

The manufacturing process may achieve distributions of carbon nanotubes (multi-wall and single-wall) bonded/physically interlocked onto the electrode material (Nickel or Stainless Steel) and, when combined with an electrolyte of KOH and/or Glacial ascetic acid acetate salt mixture. The combination demonstrates high specific capacitance and voltages between 1.2 to 18 volts of potential.

Numerous carbon nanotubes were tested and evaluated. Initially commercially available CNT were evaluated. However the results were not deemed satisfactory. It was determined that efforts should be made by the inventors to fabricate their own supply of CNT. Various methods and materials were tried and evaluated. Methane and/or ethylene were used as the carbon sources in combination with substrates (ceramic powders, and metal).

TABLE 1
CVD PROCESS RECIPIES

| PROCESS | Growth | Ethylene | Methane | Hydrogen |
|---|---|---|---|---|
| ID | Temp C. | (SLPM) | (SLPM) | (SPLM) |
| VT-CVD-1 | 700 | 0.7 | | −0.7 |
| VT-CVD-2 | 750 | 0.7 | | −0.7 |
| VT-CVD-3 | 800 | 0.7 | | −0.7 |
| VT-CVD-4 | 900 | 0.7 | | −2 |
| VT-CVD-5 | 900 | 0.5 | | −2 |
| VT-CVD-6 | 900 | 0.3 | | −2 |
| VT-CVD-7 | 900 | | −2 | 0.4 |
| VT-CVD-8 | 900 | | −2 | 0.2 |

Also catalytic solutions were used in the CVD process.

TABLE 2
Catalyst Solution Constituents

| | | | | | | 100 mesh | | Cu(NO₃)₂ |
|---|---|---|---|---|---|---|---|---|
| CAT ID | HNO₃ | Di-H₂O | MnO₂ | MgO | Al₂O₃ | Fe | Fe(NO₃)₃ | 2½H₂O |
| VT-Cat-1 | X | X | | | | | | |
| VT-Cat-2 | X | X | | | | X | | |
| VT-Cat-3 | X | X | | | X | | X | |
| VT-Cat-4 | X | X | | X | | | X | |
| VT-Cat-5 | X | X | X | X | | X | X | |
| VT-Cat-6 | X | X | X | X | X | | X | |
| VT-Cat-7 | X | X | | | | | | X |

A preferred preparation of the catalytic solution (VT-Cat-5) is composed of the following constituents: Magnesium, manganese, and iron dissolved in an aqueous bath of Nitric Acid and de-ionized water. The mass ratios of Mg:Mn:Fe:HNO₃ (15.5M):H₂O is 8:2:1:20:20 respectively. The catalytic solution can be used on Nickel foam substrates and further processed using chemical vapor deposition.

For the porous nickel substrate, 4 grams of catalytic solution were used per gram of nickel substrate. The same ratio was used for iron wool processing.

The specification also teaches an embodiment for the fabrication of CNT beginning with the sintering of Nickel or Chromium powder at 900° in an argon or nitrogen atmosphere. The substrate may be stainless steel or Nickel. The process preferably utilizes stainless steel foil with stainless steel powder. A solution containing magnesium, manganese and iron is used with the metal.

The electrolyte developed by the inventors comprises a saturated mixture of anhydrous ascetic acid (fluid) and potassium acetate salt (powder). Potassium acetate salt is added to the point of saturation. The liquid component is used as the electrolyte.

The method of manufacturing carbon nanotubes described above was used in the supply of carbon nanotubes used as the wound electrode for the ultracapacitor configured into a battery D-cell assembly.

In one embodiment, the electrodes comprise two porous Nickel plates (sintered as discussed above). Each plate is coated or pasted with a mat of carbon nanotubes. The plates are combined after a non-conductive separating material is inserted between the electrodes. In one embodiment, the separator is non woven micro-porous polypropylene (25 um thick). The sandwiched electrodes comprise a positive electrode and a negative electrode.

The configuration of the electrode is a first layer comprising sintered porous metal, a layer of CNT pasted or placed on the metal surface, the layer of non woven polypropylene, a layer of CNT pasted or placed on a second sintered and porous metal.

Prior to pasting, a conductive tab is attached to each nickel plate. The orientation of each tab is opposite to allow connection of each tab of the finished roll to be welded to the positive and negative ends of the can and cover respectively. When the electrode is combined in the final configuration as discussed above, one tab extends downward and the other tab extends upward.

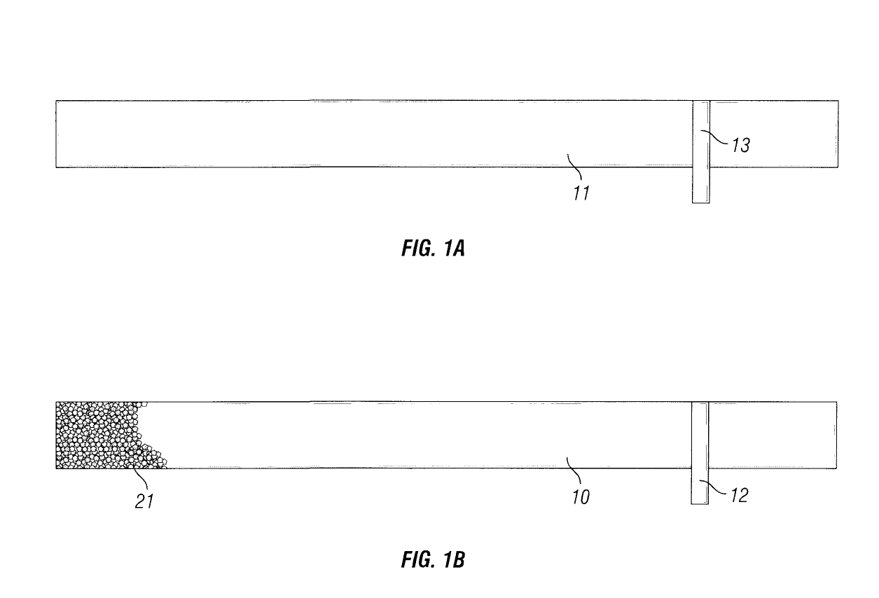

FIGS. 1A and 1B illustrates the fabrication of the two electrodes. The material 10, 11 is porous metal such as nickel. A conductive, flexible tag 12, 13 is attached to the metal strip. CNT material 21 is pasted to the entire length of one side of each metal strip. Not shown in FIG. 1A or FIG. 1B is the insulating separator layer.

Prior to winding, the flat electrode and non conductive separator are first cut to the appropriate width and length. They are then sized (calendared) to the correct thickness and wrapped in plastic as a preparation for winding. In one embodiment, the calendaring process reduced the thickness of the porous nickel and CNT from 0.060″ to 0.022″. This process physically intermeshes the CNT to the porous nickel and produces more intimate contact to reduce effective series resistance (ESR). The electrodes and separator are fed horizontally into the rollers and are then formed around the arbor.

The preferred method to make a single wound cell uses an arbor and a pair of “rocking rollers” that form the electrodes as the arbor turns. Only two rollers are required. In one embodiment, the rollers maintain surface contact on the winding electrode by use of a pneumatic cylinder that pushes the rollers into the winding. Each roller can pivot in relation to the other. Therefore the first roller can rise up when encountering the start of the winding electrode. The second roller will pivot up when encountering the progressing start of the electrode. This mechanism allows for even layering, e.g., as the arbor containing the start of the winding passes under the first roller. At completion of the winding step, the arbor is removed, creating an annulus within the combined wound electrode. (See FIG. 3) After winding, an electrical test may be performed to insure that the electrodes are not physically in contact.

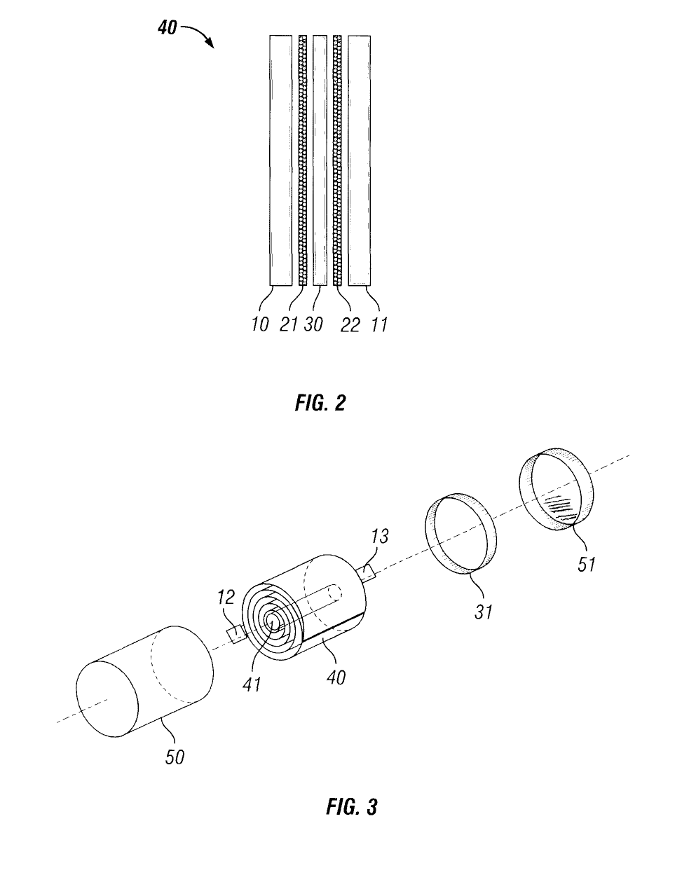

FIG. 2 is a side view of one embodiment of the assembled electrode 40. Illustrated are one metal strip 10 and the CNT layer 21 coating the strip. Also illustrated is the non conductive separator material which may be non woven polypropylene 30. Continuing there is a second layer of CNT material 22 coating a second metal strip 11. The strips are combined into a single electrode with a positive side and a negative side.

In one embodiment, the rolled electrode is inserted into an approximate 1.25 inch cylindrical shaped can. The can is dimensioned to the size of a D-cell battery. The negative tab attached to the negative electrode is placed in the center of the bottom of the can. A welding electrode can be inserted through the annulus and presses the tab to the bottom of the can. A second welding electrode of opposite charge is placed in contact with the can bottom and the negative tab is welded to the can bottom. The positive tab is welded to the can lid. The can is machined to create a groove or shelf within the interior of the can. The positive tab is then welded to the lid and the lid is fitted into the grooved can. A sealing ring (e.g., polypropylene) can be installed and the can top can be crimped over the lid. The sealing ring also acts as an insulator between the can and the lid.

Prior to crimping of the can lid, a liquid dielectric is added to the can. In various embodiments, the electrolyte is KOH, acetonitrile base, and proprietary formulations designated VT and others proprietary electrolytes.

A typical D-Cell ultracapacitor configuration may comprise a plate area of 8 sq. in.; nickel 8 grams; CNT plate 4 grams; plate mass 12 grams; and enclosure (can and lid) 20-30 grams.

FIG. 3 illustrates the open can 50 receiving the rolled electrode 40. Also shown is the annulus 41 created by the removal of the arbor. The conductive tab 12 is illustrated. This tab can be welded to the bottom of the can. Also shown is the second tab 13 which can be attached to the can lid 51. This can be the positive side of the ultracapacitor. Also shown is the non conductive element 31 or sealing ring which separates the lid and the can.

Ultracapacitors manufactured using the same methods and materials, i.e., sintering nickel, chrome or stainless steel powder on a metal substrate such as nickel or stainless steel with a catalyst comprising, for example magnesium, manganese, and iron dissolved in an aqueous bath of Nitric Acid and de-ionized water, and CNT growth processing within a temperature range of 600° C. to 1,200° C. with hydrogen and hydrocarbon precursors, etc., have demonstrated the following properties:

| | | |
|---|---|---|
| Specific Energy | 20.4 | WH/Kg |
| Specific Power | 14 | KW/kg |
| Energy Density | 30.8 | WH/L |
| Power Density | 22 | KW/L |

The above properties were measured from a double layer ultracapacitor (smaller than the D-cell configuration). This ultracapacitor demonstrated 3 times the specific power and over 20 times the specific energy of the commercially available NessCap ultracapcitor discussed below.

The D-Cell configuration taught by this specification achieves an ultracapacitor that is dimensioned and shaped like a common battery. However the ultracapacitor offers high energy density and good mechanical stability. The cylindrical configuration can also withstand high internal pressures.

The ultracapacitor was preliminarily tested and compared with a commercially available NessCap unit. A Nesscap unit is substantially larger than the D-cell sized ultracapacitor described by this specification. Nesscap products are available from 750-8, Gomae-Dong, Kiheung-Gu, Yongin, Kyonggi-Do, 449-901, Republic of Korea.

Table 3 presents results of the testing. It should be appreciated that commercially available electrolytes were used and the test does not reflect the electrolyte comprised of a saturated mixture of anhydrous ascetic acid (fluid) and potassium acetate salt (powder) disclosed within this specification.

TABLE 3
Summary of Ultracapacitor Test Results

| | | | V120303-2 | D-cell |
|---|---|---|---|---|
| | | V120606-1 | 5.5 V | 5.0 V |
| VARIABLE | NessCap | KOH | Phnx#1 | Phnx#2 |
| CNT wt (g) | unknown | 11.9 | 6.6 | 11 |
| Cell wt(g) | 985 | 117.9 | 112.6 | 112.6 |
| Cell Vol (cc) | 758.74 | 293.19 | 205.92 | 40.22 |
| Dielectric const, k | unknown | 100 | 20 | 100 |
| Breakdown | 2.7 | 1.4 | 5 | 1.4 |
| Voltage, V | | | | |
| Capacitance (F) | 5951 | 67.4 | 67.4 | 117 |
| Capacity (mAh) | 1350 | 6 | 11 | 0.275 |
| Mid-Point- | 0.7 | 0.5 | 0.6 | 0.22 |
| Voltage (MPV) | | | | |
| CNT process | unknown | Mg/Mn/NiA | Mg/Mn/Fe | Mg/Mn/NiA |
| Impregnation | unknown | pasted | pasted | pasted |
| Wh | 0.945 | 0.003 | 0.0066 | 0.0000605 |
| Wh/kg | 0.959 | 0.025 | 0.059 | 0.001 |
| Cell F/g | 6.04 | 0.57 | 0.57 | 1.04 |
| CNT F/g | n/a | 5.66 | 9.80 | 10.64 |
| CNT mAh/g | unknown | 0.50 | 1.67 | 0.03 |
| Cell mAh/g | 1.371 | 0.051 | 0.098 | 0.002 |

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention.

Further modifications and alternative embodiments of this invention will be apparent to those skilled in the art in view of this specification.

1. A method of making an ultracapacitor comprised of:
a) forming a first electrode by adhering CNT on a porous first substrate;
b) placing a non conductive separator over the first electrode;
c) forming a second electrode by adhering a second layer of CNT to a second substrate and placing over the first substrate;
d) attaching a conductive tab to each electrode;
e) rolling the combined electrodes;
f) inserting the rolled electrodes into a metal can;
g) attaching one conductive tab to the bottom of the can;
h) adding an electrolyte to the can;
i) attaching the second conductive tab to a lid of the can; and
j) placing an insulator between the lid and the can.

2. The method of claim 1 further comprising forming the electrodes:
a) using CNT manufactured from a process comprising nickel sintered on a metal substrate at least at 850° C. in an argon or nitrogen atmosphere;
b) using a catalytic solution comprised of magnesium, manganese and iron dissolved in an aqueous bath of Nitric acid and de-ionized water; and
c) growing CNT within a temperature range of 600° to 1200° C. with the addition of gas comprising methane or ethylene.

3. An ultracapacitor comprising
a) sintering nickel on a metal substrate at least at 850° C. in an argon atmosphere;
b) adding methane or ethylene to form CNT;
c) utilizing a catalytic solution comprised of magnesium, manganese and iron dissolved in an aqueous bath of Nitric acid and de-ionized water;
d) pasting the CNT to a first sintered nickel substrate to form a first electrode;
e) pasting the CNT to a second sintered nickel substrate to form a second electrode;
f) placing a non conductive material between the first electrode and the second electrode;
g) winding the combined two electrodes and non conductive layer;
h) inserting the winding into a metal can and attaching a conductive tab from one electrode to the bottom of the can;
i) inserting an electrolyte into the can;
j) attaching a second conductive tab from the other electrode to a lid of the can;
k) sealing the can with the lid using a non conductive component between the lid and the can.

4. An ultracapacitor comprised of:
a) a metal can;
b) a rolled first and second electrode wherein the electrodes are separated by non conductive material:
c) a conductive tab from a first electrode and attached to the bottom of the can;
d) an electrolyte;
e) a conductive tab from the second electrode attached to a lid to the can; and
f) a non conductive sealing material separating the can and the closed lid.

5. The ultracapacitor of claim 4 further comprising electrodes comprised of metal coated with CNT.

6. The ultracapacitor of claim 5 further comprising metal heated at a temperature of at least 850° in an argon or nitrogen atmosphere

7. The ultracapacitor of claim 4 further comprising polypropylene as the non conductive material.

8. An ultracapacitor comprising carbon nanotubes manufactured by sintering Nickel on a metal substrate at least at 850° C. in an argon atmosphere and further comprising adding methane or ethylene.

9. The ultracapacitor of claim 8 further comprising stainless steel as the substrate.

10. The ultracapacitor of claim 9 further comprising stainless steel foil as the substrate.

11. The ultracapacitor of claim 8 further comprising Nickel foil as the substrate.

12. The ultracapacitor of claim 8 further comprising an electrolyte of anhydrous ascetic acid and potassium acetate in saturation.

13. The ultracapacitor of claim 8 further comprising a catalytic solution comprised of magnesium, manganese and iron dissolved in an aqueous bath of Nitric acid and de-ionized water.

14. The catalytic solution of claim 13 further comprising a mass ratio of Mg:Mn:Fe:HNO₃(15.5M):H₂O of 8:2:1:20:20.

15. The ultracapacitor of claim 8 further comprising a rolled electrode comprised of porous metal substrate, carbon nanotubes, non conductive material, carbon nanotubes and porous metal substrate.

16. The ultracapacitor of claim 15 further comprising nickel as the metal substrate.

17. The ultracapacitor of claim 15 further comprising calendaring the electrode prior to winding.

18. The ultracapacitor of claim 15 further comprising a two roller winder wherein the rollers maintain substantially constant pressure on the electrode surface using a pneumatic cylinder.
